(19) United States
(12) Patent Application Publication
(10) Pub. No.: US 2026/0350109 A1
(43) Pub. Date: Nov. 5, 2026

(54) GENERATING PREDICTED ACTION VALUES WITHOUT COMBINING OR CROSS-USING USER DATA FROM TWO OR MORE SERVICE PLATFORMS

(71) Applicant: Google LLC, Mountain View, CA (US)

(72) Inventors: Wei Huang, Bellevue, WA (US); Liang Wang, Bellevue, WA (US); Raghuveer Chanda, Santa Clara, CA (US); Rezsa Farahani, Sunnyvale, CA (US); Yi Zhou, Sunnyvale, CA (US)

(21) Appl. No.: 19/489,132

(22) PCT Filed: Oct. 7, 2024
(86) PCT No.: PCT/US2024/050243

§ 371 Date: Dec. 1, 2025

Related U.S. Application Data
(60) Provisional application No. 63/616,460, filed on Dec. 29, 2023.

(51) Int. Cl. G06F 16/9538; G06N 3/045; G06N 3/08

(52) U.S. Cl. CPC G06F 16/9538; G06N 3/045; G06N 3/08

(57) ABSTRACT

Methods, systems, and apparatus, including computer programs encoded on computer storage media, for determining whether to provide a digital component for presentation to a user based on the one or more predicted action values for a target action. The user is registered with both a first service platform and a second service platform. The predicted action values are generated in a way that does not combine or cross-use first user data that is specific to the first service platform and second user data that is specific to the second service platform.

### BACKGROUND

This specification relates to neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification relates to techniques for training neural networks and using the trained neural networks to select content, e.g., digital components, to distribute to users based on user interactions with a service platform, e.g., an Internet-based service platform. In particular, the techniques allow for selecting digital components to be selected and presented to users in a way that preserves the security and privacy of user data.

Users connected to the Internet are exposed to a variety of digital content (e.g., search results, web pages, digital components, news articles, social media posts, audio information output by a digital assistant device). Some of these exposures to content may contribute to the users performing a target action. For example, a user that is exposed to a web page about an endangered species may sign up for a newsletter directed to helping save that endangered species, where signing up for the newsletter can be considered the target action. Similarly, a user that is exposed to a digital component in a webpage about a particular type of mobile device can ultimately acquire that particular type of mobile device, where acquisition of the mobile device can be considered the target action. Examples of target actions can also include registering with a website/service, adding items to an online cart, downloading a whitepaper, acquiring a product or even clicking (or otherwise interacting with) a digital component, or more generally any user action linked to the digital content or part of it. When a user performs a target action, performance of the target action can be referred to as a conversion.

In general, one innovative aspect of the subject matter described in this specification can be embodied in methods that include the actions of maintaining, for a user registered with both a first service platform and a second service platform, first user data specific to the first service platform and second user data specific to the second service platform; receiving session data of a current user session between the user and the first service platform; determining that combining or cross-using the first user data and the second user data is prohibited; generating, by a surrogate embedding neural network, and based on the first user data specific to the first service platform and the session data of the current user session, but without using the second user data specific to the second service platform, a surrogate cross-platform feature embedding that is a prediction of a cross-platform feature embedding that is generated by an embedding neural network based on the first user data; generating, by one or more prediction neural networks, and based on the surrogate cross-platform feature embedding, one or more predicted action values of a target action; and providing a digital component for presentation to the user based on the one or more predicted action values for the target action. Other implementations of this aspect include corresponding apparatus, systems, and computer programs, configured to perform the aspects of the methods, encoded on computer storage devices.

These and other embodiments can each optionally include one or more of the following features. In some aspects, the current user session is a search session that includes a search action, and the session data includes data related to the search action.

In some aspects, the second user data includes user profile data and log data of the second service platform.

In some aspects, generating the surrogate cross-platform feature embedding includes selecting, between the surrogate embedding neural network and the embedding neural network, the surrogate embedding neural network.

In some aspects, determining that combining or cross-using the first user data and the second user data is prohibited includes determining a consent status of the user. The consent status of the user is updated at a frequency of at most once every calendar year.

In some aspects, the first service platform is one of, and the second service platform is a different one of an online intermediation service platform, a search engine platform, a social networking service platform, a content-sharing service platform, a number-independent interpersonal communications service platform, an operating system platform, a web browser platform, a virtual assistant platform, a cloud computing service platform, or an online advertising service platform.

Some aspects include training the embedding neural network by: obtaining a batch of embedding neural network training inputs; for each embedding neural network training input included in the batch of embedding neural network training inputs: processing, by the embedding neural network, the embedding neural network training input that includes training user data specific to the second service platform to generate a training cross-platform feature embedding; and processing, by the one or more prediction neural networks, the training cross-platform feature embedding to generate one or more training predicted action values; and determining one or more updates to parameter values of the embedding neural network based on minimizing a difference between the one or more training predicted action values and one or more ground truth action values associated with the embedding neural network training input.

Some aspects include training the surrogate embedding neural network by obtaining a batch of surrogate embedding neural network training inputs; for each surrogate embedding neural network training input included in the batch of surrogate embedding neural network training inputs: processing, by the surrogate embedding neural network, the surrogate embedding neural network training input that excludes the training user data specific to the second service platform to generate a training surrogate cross-platform feature embedding; and determining one or more updates to parameter values of the surrogate embedding neural network based on minimizing a distance between the training cross-platform feature embeddings and the training surrogate cross-platform feature embeddings.

The subject matter described in this specification can be implemented in particular embodiments so as to realize one or more of the following advantages. The specification describes techniques that allow for selecting digital components to be presented to users in ways that preserves the security and privacy of user data while still providing high quality digital components even when previously available data is no longer available, e.g., due to the deprecation of third-party cookies. A surrogate embedding neural network can be trained through transfer learning to generate, based on data specific to a single service platform, surrogate cross-platform feature embeddings that are similar, e.g., almost the same as, cross-platform feature embeddings that would be generated, e.g., by a different embedding neural network, based on combining or cross-using data specific to two or more service platforms. However, such combining or cross-use of data from two or more service platforms may not be allowed in some situations, e.g., due to data privacy rules and/or user consent settings. Once trained, the surrogate cross-platform feature embeddings allow a prediction neural network to nonetheless make an accurate prediction of the action values for a target action even in the absence of data from a different service platform. Thus, in addition to providing for improved data security and privacy of user data, the techniques described in this document also provide for similar accuracy in predictions even when less information is available to make the predictions. Therefore, the techniques described in this document provide an enhanced neural network training and inference pipeline that provides accurate predictions in situations in which some data or an entire set of data is no longer available for training and inference. The use of surrogate cross-platform feature embeddings provide a particular solution and way of using artificial intelligence to enhance privacy and model accuracy in content distribution technologies.

The increased accuracy in the predicted action values makes possible a reduction in computing resource consumption and/or power consumption when selecting digital components, displaying the selected digital components, or both. For example, a service apparatus can refrain from presenting a larger number of digital components throughout a user session, and instead present a relatively smaller number of digital components only when the predicted action values satisfy, e.g., meets or exceeds, some predetermined threshold values. The savings in computing resource consumption and/or power consumption are especially important for edge devices, e.g., mobile phones, tablet computers, and smartwatches, on which the digital components are displayed, because the savings in turn improve the operational time of the edge devices and the duration between battery charges.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example environment that includes a multi-service platform.

FIG. 2 is a flow diagram of an example process for providing a digital component for presentation based on predicted action values for a target action.

FIG. 3 is a block diagram of an example training system for training a neural network.

FIG. 4 is a flow diagram of an example process for training a neural network.

FIG. 5 is a flow diagram of an example process for training a neural network.

FIG. 6 shows a block diagram of an example computer.

Like reference numbers and designations in the various drawings indicate like elements.

### DETAILED DESCRIPTION

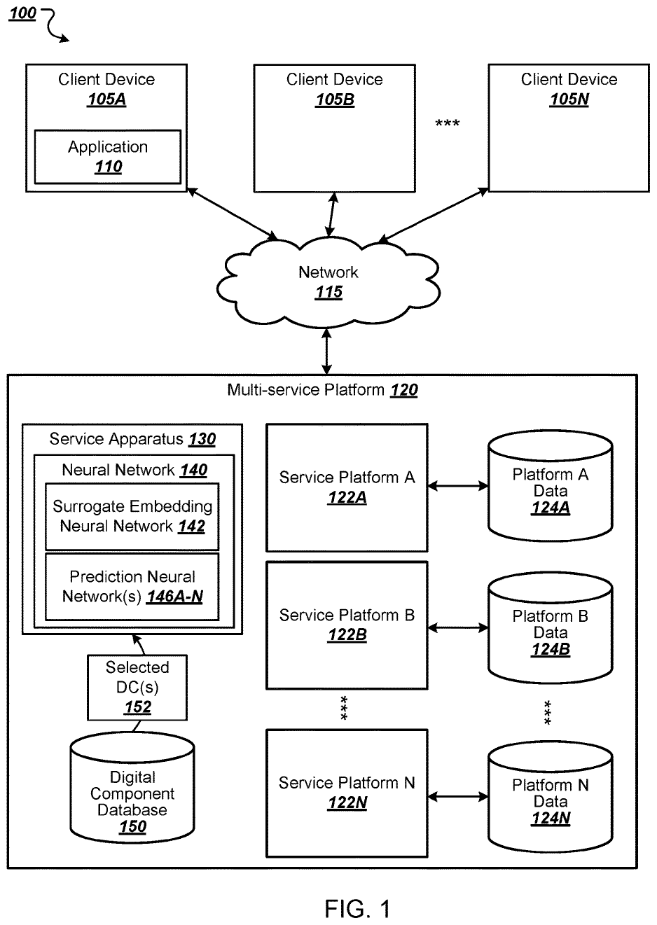

FIG. 1 is a block diagram illustrating an example environment 100 that includes client devices 105A-105N, a network 115, and a multi-service platform 120. In some implementations, the network 115 can include a local area network (LAN), a wide area network (WAN), the Internet, or a combination thereof.

The client devices 105A-105N can each include computing devices such as personal computers, gaming devices, mobile communication devices, digital assistant devices, augmented reality devices, virtual reality devices, and other devices that can send and receive data over the network 115. Each client device includes at least one application 110, such as a web browser, to facilitate the sending and receiving of data over the network 115, but native applications (other than browsers) executed by the client device can also facilitate the sending and receiving of data over the network 115. The environment 100 can support a large number of concurrent sessions with any number N of client devices 105, where N is an integer greater than or equal to one.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

The multi-service platform 120 includes a number N of multiple service platforms 122A-122N and provides multiple services to users of the platform 120. The number N can be any integer greater than one. The multi-service platform 120 can include any number of platforms, e.g., two platforms, five platforms, ten platforms, or another appropriate number.

The multi-service platform 120 can include one or more computing devices, such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components. These components can be implemented together in a single device or networked in various combinations of multiple different devices that operate together to support the functionalities of the service platforms 122A-122N.

In some examples, the multi-service platform 120 includes two or more of: an online intermediation service platform, a search engine platform, a social networking service platform, a content-sharing service platform, a number-independent interpersonal communications service platform, an operating system platform, a web browser platform, a virtual assistant platform, a cloud computing service platform, an online digital component distribution platform, or another Internet-based service platform.

In some examples, the multi-service platform 120 additionally or alternatively includes an internal or private service platform, e.g., an internal content-sharing platform of an organization. Each service platform 122A-N can interact with the client devices 105A through 105N, such as using the application 110, to communicate data between the service platform 122A-N and users of the service platform 122A-N.

As one example, the multi-service platform 120 includes a search engine platform (e.g., the service platform 122A is a search engine platform), and users interact with the search engine platform through the use of one or more of the client devices 105A-105N. For example, the client device 105A executes an application 110, such as a web browser, or another standalone application (e.g., a mobile application or mobile app), which provides a search field that allows a user to formulate search queries and submit them to the search engine platform.

The search engine platform receives a submitted query from the client device 105A, and executes the query against a content database of available documents such as web pages, images, text documents, and multimedia content. The search engine platform identifies content in the content database which matches or is otherwise responsive to the query, and responds by generating search results which are transmitted to the client device 105A in a form that can be presented to the user. For example, in response to a query from the client device 105A, the search engine platform can transmit a search results web page to be displayed in the web browser executing on the client device 105A.

As another example, the multi-service platform 120 can include a virtual assistant platform (also known as “automated assistant platform” or “mobile assistant platform”), e.g., the service platform 122B is a virtual assistant platform), that can be interacted with by users through an application 110 installed on each of one or more of the client devices 105A-105N. During operation, the virtual assistant platform receives input from the user (e.g., typed or spoken natural language input) and responds with responsive content (e.g., visual and/or audible natural language output). The virtual assistant platform can provide a broad range of functionalities through interactions with various local and/or third-party applications, websites, or other platforms.

As another example, the multi-service platform 120 can include a content-sharing service platform (e.g., the service platform 122N is a content-sharing service platform) that provides digital content, e.g., digital video, streaming video, images, digital music, streaming music, social media information, etc., to one or more of the client devices 105A-105N and can allow users to share content among multiple users. To provide digital content, for example, the content-sharing service platform can allow a user to subscribe to a paid or free channel through an application 110 installed on the client device 105A. The content-sharing service platform can present different types of access or different subscriptions levels to the user. The content-sharing service platform can also allow the user to consume, upload, search for, curate, share, approve of (e.g., “like”), dislike, and/or comment on content items of various channels.

The multi-service platform 120 includes data stores 124A-124N that correspond respectively to service platforms 122A-122N for storing data. In some implementations, each data store 124A-N can be a memory (e.g., random access memory), a cache, a drive (e.g., a hard drive), a flash drive, a database system, or another type of component or device capable of storing data. In some implementations, each data store 124A-N can include multiple storage components, e.g., multiple drives or multiple databases, that can span multiple computing devices, e.g., multiple server computers. In some implementations, the data can be stored using database, index, list, linked list, table, or any combination thereof in a corresponding data store.

In particular, the data stores 124A-124N are isolated, e.g., logically isolated or physically isolated or both, from one another. For example, the data stores 124A-124N can be implemented on distinct sets of computing devices, at distinct geographical locations, using different data structures, and so forth.

As one example, the data stores 124A-124N can store user profile data for registered users of the service platforms 122A-122N. For example, the data store 124A corresponding to the service platform 122A can store a username, or another unique identifier, of a user registered with the service platform 122A, as well as user profile data for the user that can be determined from the username. For example, the user profile data can include information about the user that the user provided when the user registered with the service platform 122A. The user profile information can include, for example, user attributes, e.g., demographic information, of the user, the geographic location of the user, the age of the user, the spoken language of the user, etc.

As another example, the data stores 124A-124N can store log data generated, e.g., collected, during interaction between the users and the service platforms. The log data includes session data of user sessions. Each user session can include one or more actions performed by the user at the client device during the session. In some cases, a user session is defined using a period of time, e.g., 10 minutes, 30 minutes, or 60 minutes, for sequential actions performed by the user. In some cases, a user session is defined to begin from the time a user provides their credentials and end at the time the user logs out or otherwise becomes inactive on a service platform.

The data to be stored in a corresponding data store for each service platform 122A-122N may, and generally, will be different from each other. For example, the user profile data, the log data, or both can differ from each other based on the provided services.

For example, assuming that the service platform 122A is a search engine platform, the session data stored in the corresponding data store 124A for each user session can include user-related session data. The session data can include data defining one or more search queries, one or more search results, one or more actions, e.g., a selection, browse, copy, or print action, performed by a user responsive to the search results, and, in some cases, metadata, e.g., geographic location and timestamp metadata, associated with the search queries.

As another example, assuming that the service platform 122B is a content-sharing service platform, the session data stored in the corresponding data store 124B for each user session can include user-related session data. The session data can include data defining what content items were viewed by a user during the user session, data defining content items that have marked by the user for later consumption, channels that the user has subscribed to, content items that the user has liked, topics the user is interested in, and so forth.

As another example, assuming that the service platform 122N is an online intermediation service platform, the session data stored in the corresponding data store 124N for each user session can include user-related session data. The session data can include data defining what products (e.g., goods or service) were viewed, selected to add to a wish list, selected to add to a cart, purchased by a user during the user session, payment information and contact information entered by the user during a session, and so forth.

In any of these examples, each user session can be assigned a unique identifier representing the user session, e.g., a number identifier, a letter identifier, a combination thereof, or the like. The session identifier can either be the same as, or different from, the username or the other unique identifier of a user associated with the user session. For example, the service platform 122A associates respective identifiers with respective session data of user sessions stored in the data store 124A. Therefore, session data of a particular user session can be retrieved by determining a particular identifier for the particular user session and using the particular identifier to find the particular session data stored in the data store 124A.

The multi-service platform 120 includes a service apparatus 130. The service apparatus 130 chooses digital components that will be presented to the client devices 105A through 105N, e.g., while they are interacting with one or more of the service platforms 122A through 122N. For example, when configured as a search engine platform, a search engine platform can integrate a digital component into a search results web page to be displayed in a web browser executing on a client device. As another example, a content-sharing service platform can integrate a digital component into, or use the digital component as, the content item to be displayed in an application executing on the client device.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

In some implementations, the service apparatus 130 identifies, e.g., selects, one or more digital components 152 that are eligible to be presented on the client devices from among a corpus of thousands or millions of available digital components. The thousands or millions of available digital components can be indexed in a digital component database 150. Each digital component index entry can reference the corresponding digital component and/or include distribution parameters that contribute to (e.g., trigger, condition, or limit) the distribution/transmission of the corresponding digital component.

While the multi-service platform 120 includes multiple service platforms 122A-122N and multiple data stores 124A-124N that correspond respectively to the multiple service platforms, however, the service apparatus 130 does not combine or cross-use respective data that is stored across the multiple data stores 124A-124N when selecting the digital components 152 for presentation to the users interacting with a given service platform. In other words, only data that is specific to a given service platform will be used by the service apparatus 130 to facilitate the selection of the digital components 152 to the users of the given service platform.

For example, to select digital components 152 to present to users of the service platform 122A, the service apparatus 130 makes use of the data stored in data store 124A that corresponds to the service platform 122A, and not data stored in any other data stores, namely data stores 124B-124N that correspond respectively to the service platforms 122A-122N. This configuration of the service apparatus 130 can be because of many reasons. One reason is to increase the security and privacy of user data stored at each data store.

Another reason is the potential difficulty in sharing data between data stores when each data store has a unique system (e.g., a legacy system) that is inflexible and cannot easily share data. Yet another reason is to comply with privacy laws, regulations, or other conditions applicable in the geographical region within which the multi-service platform system 120 is implemented.

As a particular example of this, the multi-service platform 120 can provide services in an area that requires explicit consent from users prior to combining user data from different services and processing the combined user data for certain purposes. Such regulations may also require that the multi-service platform 120 provide options to users for denying or withdrawing such consent and/or require that the multi-service platform 120 seek the consent at a frequency that is no more than once every calendar year.

In lieu of combining or cross-using respective data stored across the multiple data stores 124A through 124N, the service apparatus 130 uses machine learning techniques to facilitate the selection of the digital components 152 from the digital component database 150 that will be provided for presentation on the client devices 105A through 105N without combining or cross-using the respective data stored across the multiple data stores 124A through 124N. The service apparatus 130 includes one or more neural networks, e.g., the neural network 140, and determines whether a digital component from the digital component database 150 should be selected as the selected digital component 152, based on the outputs of the neural networks included in the service apparatus 130.

In some implementations, the service apparatus 130 can request, e.g., query, the neural network 140 to generate one or more predicted action values for a target action, e.g., a target action that can be performed on a digital component that is available for presentation on any one of the client devices 105A through 105N or after viewing the digital component. For example, the target action can be user interaction with the digital component, adding an item to a virtual shopping cart after viewing or interacting with the digital component, registering for a newsletter related to the subject of the digital component, etc. The service apparatus 130 can use at least the predicted action values to determine whether to present a selected digital component 152 on the client device. In response to a positive determination, the service apparatus 130 can generate and transmit, over the network 115, data that enables a client device to present the selected digital component 152 at a display of the client device.

For example, the service apparatus 130 can select the digital component having the highest predicted action value among a set of candidate digital components for which the service apparatus 130 determined the predicted action values. In another example, the service apparatus 130 can select a digital component having a highest combined score that is the combination of the predicted action value for the digital component, a selection parameter, and/or other values. The selection parameter can be an amount that the digital component provider that publishes the digital component is willing to provide a publisher in exchange for presenting the digital component.

In some implementations, the service apparatus 130 can include multiple neural networks that correspond respectively to the multiple service platforms 122A-N. For example, the service apparatus 130 can include a first neural network corresponding to service platform A 122A, a second neural network corresponding to service platform B 122B, and so on. For a given service platform, the corresponding neural network generates outputs that facilitate the selection of digital component 152 to be presented to users of the given service platform. For example, the neural network can generate an output for each digital component request received by the service apparatus 130 for that platform and the service apparatus 130 can use the output to select a digital component to provide in response to the digital component request.

As illustrated in FIG. 1, the neural network 140 includes a surrogate embedding neural network 142 and one or more prediction neural network(s). The surrogate embedding neural network 142 is configured to receive, as input, session data of a current user session between a user and a given service platform, e.g., service platform 122A, and/or data retrieved from a data store corresponding to the given service platform, e.g., data store 124A, and process the input to generate, as output, a surrogate cross-platform embedding. An embedding refers to an ordered collection of numerical values, e.g., a vector, matrix, or other tensor of numerical values. The one or more prediction neural network(s) 146A-N are configured to receive, as input, the surrogate cross-platform embedding, and process the surrogate cross-platform embedding to generate, as output, the one or more predicted action values.

Although the techniques described throughout this document are related to selecting digital components, the techniques can be used for other purposes. For example, the techniques can be used to train machine learning models to predict user attributes (e.g., user demographics), select resources (e.g., web pages) to provide search results in response to queries, predict user actions on the platforms or off the platforms, recommend content on the platforms (e.g., to recommend videos on a video sharing platform), etc.

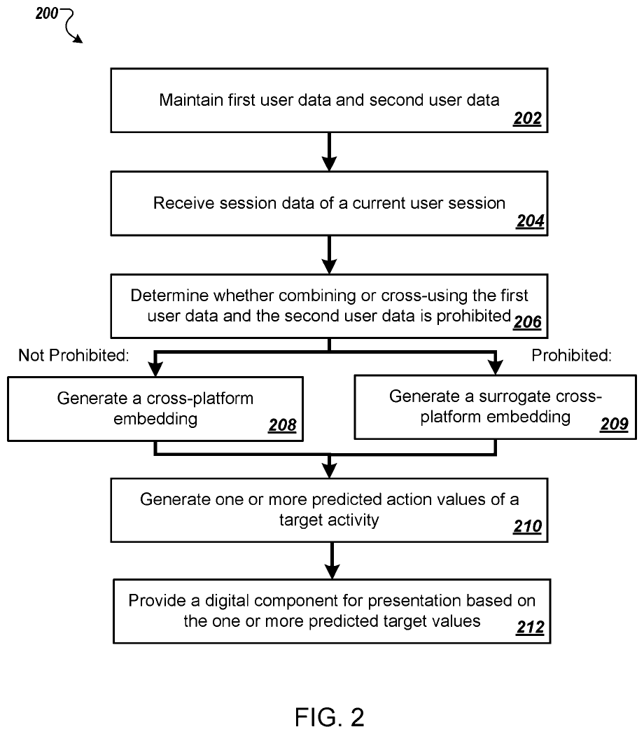

FIG. 2 is a flow diagram of an example process 200 for providing a digital component for presentation based on predicted action values for a target action. For example, a multi-service platform, e.g., the multi-service platform 120 of FIG. 1, appropriately programmed in accordance with this specification, can perform the process 200. Operations of the process 200 can also be implemented as instructions stored on one or more computer-readable media, which may be non-transitory, and execution of the instructions by one or more data processing apparatus can cause the one or more data processing apparatus to perform the operations of the process 200.

The multi-service platform includes one or more computing devices located in one or more locations. The multi-service platform includes at least a first service platform and a second service platform. The multi-service platform includes a service apparatus, which in turn, includes a neural network that corresponds to the first service platform. The neural network includes an embedding neural network, a surrogate embedding neural network, and one or more prediction neural networks.

The first service platform provides different services than the second service platform. For example, the first service platform can be a search engine service platform that provides a search engine service, the second service platform can be a content-sharing service platform that provides a content-sharing service. As another example, the first service platform can be a cloud computing service that provides a cloud computing service, and the second service platform can be an online intermediation service that provides an online intermediation service. Other services are also possible.

The multi-service platform maintains, for a user registered with both the first service platform and the second service platform, first user data specific to the first service platform and second user data specific to the second service platform (operation 202). The first user data is stored in a first data store that corresponds to the first service platform, while the second user data is stored in a second data store that corresponds to the second service platform. The first data store is isolated (e.g., logically isolated or physically isolated or both) from the second data store.

For example, the first user data can include a username, or another unique identifier, of the user registered with the first service platform, as well as user profile data on the first service platform for the user that can be determined from the username. Likewise, the second user data can include a username, or another unique identifier, of the user registered with the second service platform, as well as user profile data on the second service platform for the user that can be determined from the username.

As another example, the first user data can include log data generated during past interaction between the user and the first service platform. The log data includes session data of historical user sessions. Each historical user session can include data describing one or more historical actions performed by the user on the first service platform, e.g., through an application installed on a client device, during the historical user session. Likewise, the second user data can include log data generated during past interaction between the user and the second service platform. The log data includes session data of historical user sessions. Each historical user session can include data describing one or more historical actions performed by the user on the second service platform, e.g., through an application installed on a client device, during the historical user session.

The log data for each platform can also include, for each user session, data describing other events that occur during the user sessions that may not be user actions. For example, the events can include content displayed to the user (e.g., search results, videos, audio, etc.), digital components presented to the user, etc. The log data for each user session can also include contextual data, e.g., timestamps that indicate when events/actions occurred during the user session, coarse location information that identifies the region of the client device when the event/action occurred, the spoken language of the user, etc.

The multi-service platform receives session data of a current user session between the user and the first service platform (operation 204). The current user session includes one or more actions performed by the user on the first service platform, e.g., through an application installed on a client device, during the current user session, and/or event data for other events. As described above, the session data can include user data, and can also include non-user data.

The multi-service platform determines whether combining or cross-using the first user data and the second user data is prohibited (operation 206). This determination can be made in many different ways. For example, a default configuration of the multi-service platform might prohibit it from combining or cross-using respective user data stored across the first and second data stores. As another example, a consent status of the user might indicate that the multi-service platform is prohibited from combining or cross-using, for that user, the first user data and the second user data.

In response to determining that combining or cross-using the first user data and the second user data is allowed, i.e., is not prohibited, the process 200 proceeds from operation 206 to operation 208. In other words, the multi-service platform selects, between the embedding neural network and the surrogate embedding neural network, the embedding neural network to perform the inference in response to determining that combining or cross-using the first user data and the second user data is not prohibited.

The multi-service platform generates, by the embedding neural network included in the neural network, based on the first user data that is specific to the first service platform, the second user data that is specific to the second service platform, and, in some cases, the session data of the current user session between the user and the first service platform, a cross-platform embedding (operation 208). For example, the embedding neural network can process second user data that includes at least the user profile data on the second service platform for the user to generate the cross-platform feature embedding.

Alternatively, in response to determining that combining or cross-using the first user data and the second user data is prohibited, the process 200 proceeds from operation 206 to operation 209.

The multi-service platform generates, by the surrogate embedding neural network included in the neural network, and based on the first user data that is specific to the first service platform and the session data of the current user session, but without using the second user data that is specific to the second service platform, a surrogate cross-platform feature embedding (operation 209).

The surrogate cross-platform feature embedding is a prediction of a cross-platform feature embedding that would be generated by the embedding neural network based on the first user data that is specific to the first service platform, the second user data that is specific to the second service platform, and, in some cases, the session data of the current user session between the user and the first service platform.

In some implementations, the surrogate cross-platform feature embedding can have the same dimensionality as the cross-platform feature embedding. That is, the cross-platform feature embedding includes multiple values and the surrogate cross-platform feature embedding includes the same number of values. These values are different from, although similar to, each other. For example, the values included in the surrogate cross-platform feature embedding are within a predetermined distance from the values included in the cross-platform feature embedding.

In other words, the multi-service platform selects, between the embedding neural network and the surrogate embedding neural network, the surrogate embedding neural network to perform the inference in response to determining that combining or cross-using the first user data and the second user data is prohibited. In lieu of using the embedding neural network to perform inference, the multi-service platform uses the surrogate embedding neural network to generate an embedding that is similar to a cross-platform feature embedding that would otherwise need to be generated by using the embedding neural network based on combining or cross-using user data specific to two or more different platforms.

The multi-service platform generates, by one or more prediction neural networks, and based on the surrogate cross-platform feature embedding, one or more predicted action values (operation 210). The predicted action values are typically defined with reference to a target action. Example target actions are described elsewhere herein. For example, the predicted action values can include a value that indicates a likelihood of a target action being performed by the user during a user session or following the user session. As another example, the predicted action values can include a value that indicates a time duration of the target action being performed. As yet another example, the predicted action values can include a predicted conversion rate for a digital component, e.g., a predicted likelihood of a user clicking or otherwise interacting with a digital component upon viewing the digital component or the user performing a specified action after viewing or interacting with the digital component.

Different prediction neural networks can be configured to generate different predicted action values for the same target action based on processing the surrogate cross-platform feature embedding. For example, a first action value prediction head can generate a first prediction neural network that indicates a likelihood of the target action being performed, a second prediction neural network can generate a second predicted action value that indicates a time length of the target action being performed, and so on.

The multi-service platform provides a given digital component for presentation to the user based on the one or more predicted action values for the target action (operation 212). The multi-service platform can select the given digital component from among a set of candidate digital components based on one or more predicted action values for each candidate digital component. For example, the multi-service platform can use the prediction neural network to generate one or more predicted action values for each candidate digital component. In this example, the multi-service platform can select, as the given digital component, the candidate digital component having the highest predicted action value or a highest combination (e.g., sum, average, or product of), multiple predicted action values generated for each candidate digital component. In another example, the multi-service platform can select the given digital component based on a score that is based on a combination of the predicted action value(s) for the given digital component and a selection parameter, which can be an amount, e.g., a monetary amount, that the publisher of the given digital component is willing to provide to a publisher in exchange for the given digital component being presented with a resource, e.g., webpage, of the publisher.

In another example, the multi-service platform can determine that the given digital component should be selected for presentation to the user if each predicted action value satisfies a corresponding predetermined threshold action value. In turn, the multi-service platform can deliver the given digital component to the client device, which then presents the given digital component on a computer display of the client device. Alternatively, the multi-service platform can determine that the given digital component should not be selected as the selected digital component if at least one predicted action value fails to satisfy a corresponding predetermined threshold action value.

In given digital component in operation 212 can be any digital component from the digital component database 150 of FIG. 1. For example, the given digital component can be selected by another component of the service apparatus 130. The other component can be, but need not be, a machine learning model. Merely as an example, it can be a rule-based engine that analyzes the digital component database 150 to identify various digital components having distribution parameters that match the current user session between the user and the first service platform.

In various implementations, the process 200 can be performed prior to, in conjunction with, or subsequent to the actual selection of the given digital component. Advantageously, when performed prior to the actual selection process, assuming the one or more predicted action values do not satisfy the corresponding predetermined threshold action values, then no digital component needs to be selected from the digital component database 150. Because a selection process is not performed, the computing resource consumption and/or power consumption of the multi-service platform can be reduced.

Prior to being used to perform inference, the service apparatus 130, or a separate training system, trains the neural network 140 on training data to determine trained value of the parameters of the neural network that can allow it to achieve an acceptable level of accuracy in predicting the action values.

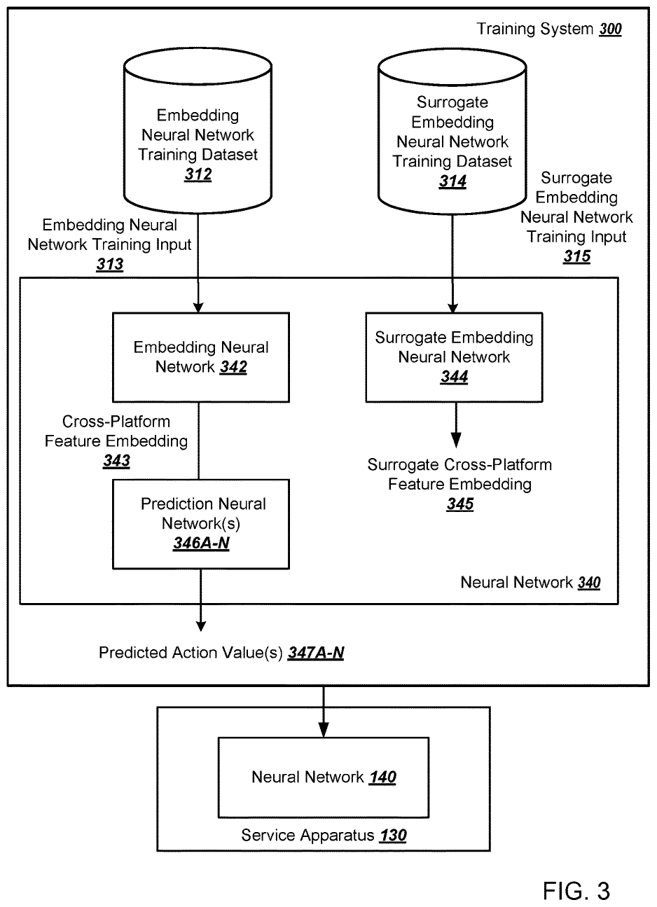

FIG. 3 is a block diagram of an example training system 300 for training a neural network 340. The training system 300 is an example of a system implemented as computer programs on one or more computers in one or more locations that trains the neural network 340 on an embedding neural network training dataset 312 and a surrogate embedding neural network training dataset 314 to determine trained values of the parameters of the neural network 340.

Generally, the embedding neural network training dataset 312 differs from the surrogate embedding neural network training dataset 314 in that the embedding neural network training dataset 312 is generated based on data obtained from two or more of the data stores 124A through 124N that correspond respectively to two or more of the service platforms 122A through 122N, whereas the surrogate embedding neural network training dataset 314 is generated based on data obtained from just one of the data store 124A through 124N.

For example, the embedding neural network training dataset 312 can be generated from user profile data of two or more service platforms. As another example, the embedding neural network training dataset 312 can be generated from log data collected during interaction between users and each of two or more of the service platforms 122A through 122N. The log data can include session data of the user sessions between a user and a service platform.

More specifically, the embedding neural network training dataset 312 includes multiple embedding neural network training inputs 313. Each embedding neural network training input 313 includes values for multiple features. The multiple features can include features generated from both user profile data of a user registered with a first service platform and user profile data of a user (potentially the same user) registered with a second service platform. Additionally, or alternatively, the multiple features can include features generated from both session data of one or more user sessions between a user and the first service platform, and session data of one or more user sessions between a user (potentially the same user) and the second service platform.

On the other hand, for example, the surrogate embedding neural network training dataset 314 can be generated from user profile data of the first service platform, but not from user profile data of the second service platform. As another example, the surrogate embedding neural network training dataset 314 can be generated from log data collected during interaction between the users and the first service platform, but not from log data collected during interaction between the users and second first service platform.

More specifically, the embedding neural network training dataset 314 includes multiple surrogate embedding neural network training inputs 315. Each surrogate embedding neural network training input 315 includes values for multiple features. The multiple features can include features generated from user profile data of a user registered with a first service platform. Additionally, or alternatively, the multiple features can include features generated from session data of one or more user sessions between a user and the first service platform. In particular, the multiple features do not include, i.e., the multiple features exclude, any features generated from user profile data of a user registered with a second service platform, or any features generated from session data of one or more user sessions between the user and the second service platform.

The neural network 340 includes an embedding neural network 342. The embedding neural network 342 is configured to extract features from the embedding neural network training inputs 313, that is, configured to process the embedding neural network training inputs 313 to generate a cross-platform feature embedding 343 for each embedding neural network training input 313. The cross-platform feature embedding is referred to as a “cross-platform” feature embedding because it is generated by the embedding neural network 342 based on processing features generated from the user profile data, log data, or both of two service platforms.

The neural network 340 includes a surrogate embedding neural network 344. The embedding neural network 342 is configured to extract features from the surrogate embedding neural network training inputs 315, that is, configured to process the surrogate embedding neural network training inputs 315 to generate a surrogate cross-platform feature embedding 345 for each surrogate embedding neural network training input 345. The surrogate cross-platform feature embedding 345 can have the same dimensionality as the cross-platform feature embedding 343, and is referred to as a “surrogate” cross-platform feature embedding because it is generated by the surrogate embedding neural network 344 based on processing features generated from the user profile data, log data, or both of the first service platform (and not the second service platform).

The neural network 340 also includes one or more prediction neural networks 346A-N. The prediction neural networks 346A-N are configured to process the cross-platform feature embeddings 343 generated by the embedding neural network 342 from an embedding neural network training input 313 to generate one or more predicted action values 347A-N, respectively, for the embedding neural network training input 313.

The predicted action values are typically defined with reference to a target action. Example target actions are described elsewhere herein. For example, the predicted action values 347A-N can include a value that indicates a likelihood of a target action being performed by the user during the user session. As another example, the predicted action values 347A-N can include a value that indicates a time length of the target action being performed. As yet another example, the predicted action values 347A-N can include a predicted conversion rate for a digital component.

The embedding neural network 342, the surrogate embedding neural network 344, and the prediction neural networks 346A-N can each be implemented with any appropriate neural network architecture that enables them to perform their described functions. For example, they can each include any appropriate types of neural network layers (e.g., fully connected layers, attention layers, activation layers, and so forth) in any appropriate number (e.g., 5 layers, or 10 layers, or 50 layers) and connected in any appropriate configuration (e.g., as a directed graph of layers).

As a particular example, the embedding neural network 342 can have a two-tower architecture, where a first tower processes a first subset of features included in an embedding neural network training input 313 to generate a first intermediate embedding, and a second tower processes a second subset of features included in the embedding neural network training input 313 to generate a second intermediate embedding, which can be combined and, in some cases, further processed by a shared head of the embedding neural network 342 to generate the cross-platform feature embeddings 343 as output of the embedding neural network 342.

The training system 300 performs the training over multiple training iterations. At each training iteration, the training system 300 updates the parameters of the neural network 340 by performing a forward pass through the neural network using the training inputs obtained from the training datasets 312 or 314 and then perform a backward pass through the neural network 340 to compute the respective gradients through backpropagation.

In some implementations, the training system 300 performs the training using a two-stage process. During the first stage of training process, the training system 300 trains the embedding neural network 342 on the embedding neural network training dataset 312 to generate semantically meaningful cross-platform feature embeddings 343 of the embedding neural network training inputs 313, and trains the prediction neural networks 346A-N to generate more accurate predicted action values 347A-N, i.e., to generate predicted action values that are close to the ground truth action values associated with the embedding neural network training inputs 313.

During the second stage of training process, the training system 300 trains the surrogate embedding neural network 344 on the surrogate embedding neural network training dataset 314 to generate surrogate cross-platform feature embeddings 345 that are proximate in distance to the cross-platform feature embeddings 343 generated by the embedding neural network 342 in an embedding space. These distances, or “similarities,” in the embedding space can be computed in various ways, such as with cosine similarity, dot products, etc.

In this way, the training system 300 encourages the surrogate cross-platform feature embeddings 345 generated by the surrogate embedding neural network 344 to encode enough information, e.g., semantic or other contextual information, for the surrogate embedding neural network training inputs 315. In particular, the training system 300 trains the surrogate embedding neural network 344 to encode enough information, which is similar to what would be encoded in the cross-platform feature embeddings 343, in the surrogate cross-platform feature embeddings 345 from processing the surrogate embedding neural network training input 315, despite that the surrogate embedding neural network training input 315 generally includes a smaller number of features than the embedding neural network training input 313 (because it does not include any features generated from the user profile data, log data, or both of the second service platform).

After the training, the training system 300 outputs at least a portion of the trained neural network 340 to the service apparatus 130 of FIG. 1 for deployment to perform inference. For example, the training system 300 outputs the surrogate embedding neural network 344 and the one or more prediction neural networks 346A-N to the service apparatus 130 for inclusion in the neural network 140 (as the surrogate embedding neural network 142 and the one or more prediction neural networks 146A-N, respectively of the neural network 140) that is included in the service apparatus 130 to perform inference.

Optionally, the training system 300, the service apparatus 130, or a different system can further fine-tune some or all of the parameters of the neural network 340 before using it to perform inference. When included in the neural network 140, the parameters of the trained parameter values of the surrogate embedding neural network 344 and the one or more prediction neural networks 346A-N may be frozen, or they may be further trained, e.g., on different training datasets, using a different loss function, or both, e.g., in conjunction with the parameters of the other layers of the neural network 140.

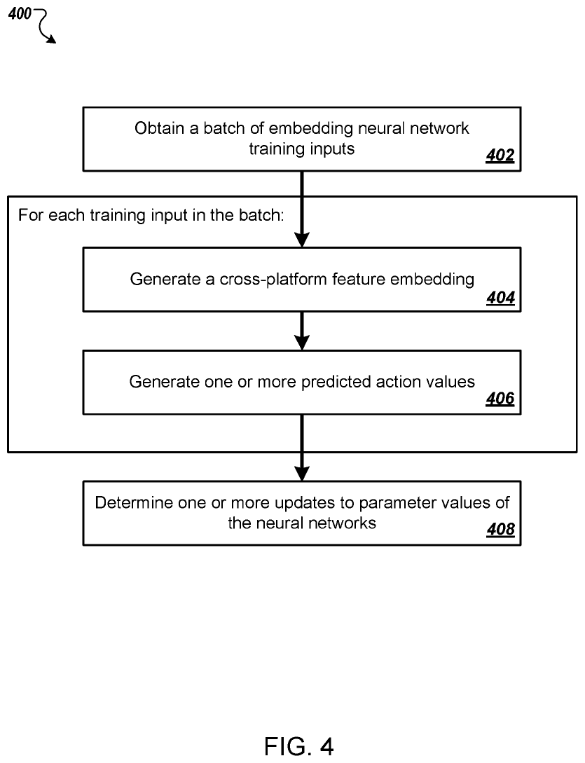

FIG. 4 is a flow diagram of an example process 400 for training a neural network. For convenience, the process 400 will be described as being performed by a system of one or more computers located in one or more locations. For example, a training system, e.g., the training system 300 of FIG. 3, appropriately programmed in accordance with this specification, can perform the process 400. Operations of the process 400 can also be implemented as instructions stored on one or more computer-readable media, which may be non-transitory, and execution of the instructions by one or more data processing apparatus can cause the one or more data processing apparatus to perform the operations of the process 400.

The system can repeatedly perform iterations of the process 400 on different batches of embedding neural network training inputs to update the parameters of the embedding neural network and the one or more prediction neural networks included in the neural network.

The system can continue performing iterations of the process 400 until termination criteria for the first stage training of the neural network have been satisfied, e.g., until the parameters have converged, until a threshold amount of wall clock time has elapsed, or until a threshold number of iterations of the process 400 have been performed.

The system obtains a batch of embedding neural network training inputs from an embedding neural network training dataset (operation 402). The system will generally obtain different embedding neural network training inputs at different iterations, e.g., by sampling a fixed number of training inputs from a larger number of embedding neural network training inputs at each iteration. Each embedding neural network training input is associated with one or more ground truth action values for a target action that can be performed by a user during the corresponding user session.

The embedding neural network training dataset can be generated based on data obtained from two or more of the data stores that correspond respectively to two or more service platforms that provide different services. The training dataset includes multiple training inputs. Each training input includes multiple features. The multiple features can include features generated from both user profile data of a user registered with a first service platform and user profile data of a user (potentially the same user) registered with a second service platform. Additionally, or alternatively, the multiple features can include features generated from both session data of one or more user sessions between a user and the first service platform, and session data of one or more user sessions between a user (potentially the same user) and the second service platform.

The system repeatedly performs following operations 404-406 for each embedding neural network training input included in the batch obtained from the embedding neural network training dataset.

The system processes, by the embedding neural network, an embedding neural network training input to generate a training cross-platform embedding (operation 404).

The system processes, by the one or more prediction neural networks, the training cross-platform embedding to generate one or more training predicted action values (operation 406). Different prediction neural networks can be configured to generate different predicted action values for the same target action based on processing the training cross-platform embedding. For example, a prediction neural network can generate a first predicted action value that indicates a likelihood of the target action being performed, a prediction neural network can generate a second predicted action value that indicates a time length of the target action being performed, and so on.

The system determining one or more updates to parameter values of the embedding neural network and the one or more prediction neural networks included in the neural network (operation 408). The system can do this by computing, for each embedding neural network training input in the batch, respective gradients of the loss function with respect to the parameters of the neural network by backpropagation through the appropriate parameters of the neural network. The system can then determine the updates by applying an update rule, e.g., an Adam update rule, an Rmsprop update rule, or a stochastic gradient descent (SGD) update rule, to the respective gradients.

The loss function can include one or more action value loss terms that are defined with respect to the outputs of the one or more prediction neural networks. The action value loss terms can be used to update parameter values of the one or more one or more prediction neural networks of the neural network and, by virtue of backpropagation, parameter values of the embedding neural network included in the neural network.

For example, the loss function can include an action value loss term that corresponds to a respective predicted action value. In this example, each action value loss term measures, for each embedding neural network training input in the batch, a difference between a predicted action value and a corresponding ground truth action value associated with the embedding neural network training input.

As another example, the loss function can include one action value loss term that corresponds to all of the predicted action values, and measures, for each embedding neural network training input in the batch, a combined difference between the one or more predicted action values and their corresponding ground truth action values associated with the embedding neural network training input.

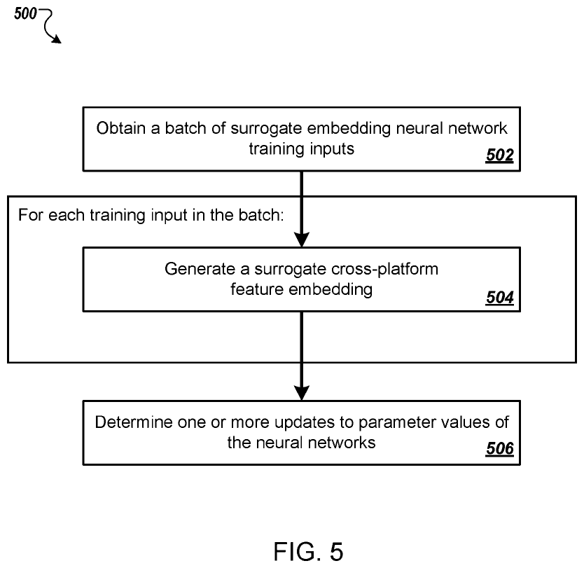

FIG. 5 is a flow diagram of an example process 500 for training a neural network. For convenience, the process 500 will be described as being performed by a system of one or more computers located in one or more locations. For example, a training system, e.g., the training system 300 of FIG. 3, appropriately programmed in accordance with this specification, can perform the process 500. Operations of the process 500 can also be implemented as instructions stored on one or more computer-readable media, which may be non-transitory, and execution of the instructions by one or more data processing apparatus can cause the one or more data processing apparatus to perform the operations of the process 500.

The system can repeatedly perform iterations of the process 500 on different batches of surrogate embedding neural network training inputs to update the parameters of the surrogate embedding neural network included in the neural network.

The system can continue performing iterations of the process 500 until termination criteria for the second stage training of the neural network have been satisfied, e.g., until the parameters have converged, until a threshold amount of wall clock time has elapsed, or until a threshold number of iterations of the process 500 have been performed.

The system obtains a batch of surrogate embedding neural network training inputs from a surrogate embedding neural network training dataset (operation 502). The system will generally obtain different surrogate embedding neural network training inputs at different iterations, e.g., by selecting a fixed number of surrogate embedding neural network training inputs that map respectively to the batch embedding neural network training inputs at a corresponding iteration during the first stage training of the neural network.

The surrogate embedding neural network training dataset can be generated from user profile data of the first service platform, but not from user profile data of the second service platform. The training dataset includes multiple training inputs. Each training input includes multiple features. The multiple features can include features generated from user profile data of a user registered with a first service platform. Additionally, or alternatively, the multiple features can include features generated from session data of one or more user sessions between a user and the first service platform. In particular, the multiple features do not include any features generated from user profile data of a user registered with a second service platform, or any features generated from session data of one or more user sessions between the user and the second service platform.

The system processes, by the surrogate embedding neural network, a surrogate embedding neural network training input to generate a training surrogate cross-platform feature embedding (operation 504). Operation 504 can be repeatedly performed for each surrogate embedding neural network training input included in the batch obtained from the surrogate embedding neural network training dataset.

The system determines one or more updates to parameter values of the surrogate embedding neural network included in the neural network (operation 506). The system can do this by computing, for each surrogate embedding neural network training input in the batch, respective gradients of the loss function with respect to the parameters of the neural network by backpropagation through the appropriate parameters of the neural network. The system can then determine the updates by applying an update rule, e.g., an Adam update rule, an Rmsprop update rule, or a stochastic gradient descent (SGD) update rule, to the respective gradients.

The loss function can include a surrogate loss term that is defined with respect to the outputs of surrogate embedding neural network. The surrogate loss term measures, for each surrogate embedding neural network training input in the batch, a distance between the between the training cross-platform feature embedding generated by the embedding neural network and the training surrogate cross-platform feature embedding generated by the surrogate embedding neural network. These distances, or “similarities,” in the embedding space can be computed in various ways, such as with cosine similarity, dot products, etc. The surrogate loss term can be used to update parameter values of the surrogate embedding neural network included in the neural network.

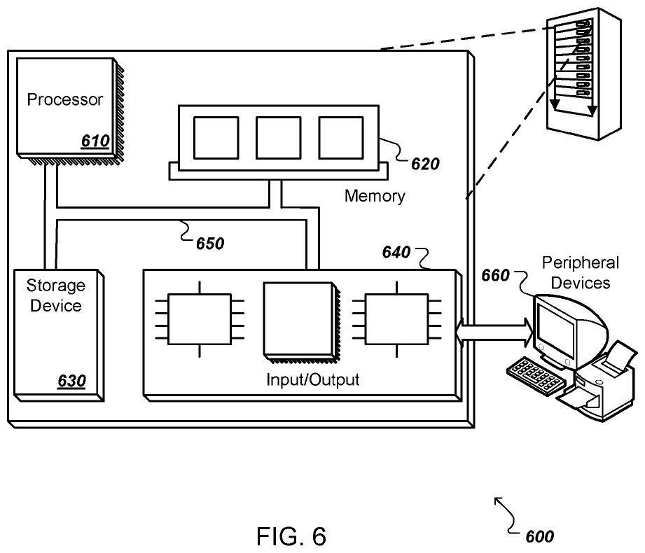

FIG. 6 is a block diagram of an example computer system 600 that can be used to perform operations described above, according to an implementation of the present disclosure. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 660. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
maintaining, for a user registered with both a first service platform and a second service platform, first user data specific to the first service platform and second user data specific to the second service platform;
receiving session data of a current user session between the user and the first service platform;
determining that combining or cross-using the first user data and the second user data is prohibited;
generating, by a surrogate embedding neural network, and based on the first user data specific to the first service platform and the session data of the current user session, but without using the second user data specific to the second service platform, a surrogate cross-platform feature embedding that is a prediction of a cross-platform feature embedding that is generated by an embedding neural network based on the first user data;
generating, by one or more prediction neural networks, and based on the surrogate cross-platform feature embedding, one or more predicted action values of a target action; and
providing a digital component for presentation to the user based on the one or more predicted action values for the target action.

2. The method of claim 1, wherein the current user session is a search session that includes a search action, and the session data comprise data related to the search action.

3. The method of claim 1, wherein the second user data comprises user profile data and log data of the second service platform.

4. The method of claim 1, wherein generating the surrogate cross-platform feature embedding comprises:
selecting, between the surrogate embedding neural network and the embedding neural network, the surrogate embedding neural network.

5. The method of claim 1, wherein determining that combining or cross-using the first user data and the second user data is prohibited comprises determining a consent status of the user.

6. The method of claim 5, wherein the consent status of the user is updated at a frequency of at most once every calendar year.

7. The method of claim 1, wherein the first service platform is one of, and the second service platform is a different one of:
an online intermediation service platform, a search engine platform, a social networking service platform, a content-sharing service platform, a number-independent interpersonal communications service platform, an operating system platform, a web browser platform, a virtual assistant platform, a cloud computing service platform, or an online advertising service platform.

8. The method of claim 1, further comprising training the embedding neural network by:
obtaining a batch of embedding neural network training inputs;
for each embedding neural network training input included in the batch of embedding neural network training inputs:
processing, by the embedding neural network, the embedding neural network training input that includes training user data specific to the second service platform to generate a training cross-platform feature embedding; and
processing, by the one or more prediction neural networks, the training cross-platform feature embedding to generate one or more training predicted action values; and
determining one or more updates to parameter values of the embedding neural network based on minimizing a difference between the one or more training predicted action values and one or more ground truth action values associated with the embedding neural network training input.

9. The method of claim 8, further comprising training the surrogate embedding neural network by:
obtaining a batch of surrogate embedding neural network training inputs;
for each surrogate embedding neural network training input included in the batch of surrogate embedding neural network training inputs:
processing, by the surrogate embedding neural network, the surrogate embedding neural network training input that excludes the training user data specific to the second service platform to generate a training surrogate cross-platform feature embedding; and
determining one or more updates to parameter values of the surrogate embedding neural network based on minimizing a distance between the training cross-platform feature embeddings and the training surrogate cross-platform feature embeddings.

10. A system comprising one or more computers and one or more storage devices storing instructions that when executed by the one or more computers cause the one more computers to perform operations comprising:
maintaining, for a user registered with both a first service platform and a second service platform, first user data specific to the first service platform and second user data specific to the second service platform;
receiving session data of a current user session between the user and the first service platform;
determining that combining or cross-using the first user data and the second user data is prohibited;
generating, by a surrogate embedding neural network, and based on the first user data specific to the first service platform and the session data of the current user session, but without using the second user data specific to the second service platform, a surrogate cross-platform feature embedding that is a prediction of a cross-platform feature embedding that is generated by an embedding neural network based on the first user data;
generating, by one or more prediction neural networks, and based on the surrogate cross-platform feature embedding, one or more predicted action values of a target action; and
providing a digital component for presentation to the user based on the one or more predicted action values for the target action.

11. One or more non-transitory computer storage media storing instructions that when executed by one or more computers cause the one more computers to perform operations comprising:
maintaining, for a user registered with both a first service platform and a second service platform, first user data specific to the first service platform and second user data specific to the second service platform;
receiving session data of a current user session between the user and the first service platform;
determining that combining or cross-using the first user data and the second user data is prohibited;
generating, by a surrogate embedding neural network, and based on the first user data specific to the first service platform and the session data of the current user session, but without using the second user data specific to the second service platform, a surrogate cross-platform feature embedding that is a prediction of a cross-platform feature embedding that is generated by an embedding neural network based on the first user data;
generating, by one or more prediction neural networks, and based on the surrogate cross-platform feature embedding, one or more predicted action values of a target action; and
providing a digital component for presentation to the user based on the one or more predicted action values for the target action.

12. The system of claim 10, wherein the current user session is a search session that includes a search action, and the session data comprise data related to the search action.

13. The system of claim 10, wherein the second user data comprises user profile data and log data of the second service platform.

14. The system of claim 10, wherein generating the surrogate cross-platform feature embedding comprises:
selecting, between the surrogate embedding neural network and the embedding neural network, the surrogate embedding neural network.

15. The system of claim 10, wherein determining that combining or cross-using the first user data and the second user data is prohibited comprises determining a consent status of the user.

16. The system of claim 15, wherein the consent status of the user is updated at a frequency of at most once every calendar year.

17. The system of claim 10, wherein the first service platform is one of, and the second service platform is a different one of:
an online intermediation service platform, a search engine platform, a social networking service platform, a content-sharing service platform, a number-independent interpersonal communications service platform, an operating system platform, a web browser platform, a virtual assistant platform, a cloud computing service platform, or an online advertising service platform.

18. The system of claim 10, wherein the operations further comprise training the embedding neural network by:
obtaining a batch of embedding neural network training inputs;
for each embedding neural network training input included in the batch of embedding neural network training inputs:
processing, by the embedding neural network, the embedding neural network training input that includes training user data specific to the second service platform to generate a training cross-platform feature embedding; and
processing, by the one or more prediction neural networks, the training cross-platform feature embedding to generate one or more training predicted action values; and
determining one or more updates to parameter values of the embedding neural network based on minimizing a difference between the one or more training predicted action values and one or more ground truth action values associated with the embedding neural network training input.

19. The system of claim 18, wherein the operations further comprise training the surrogate embedding neural network by:
obtaining a batch of surrogate embedding neural network training inputs;
for each surrogate embedding neural network training input included in the batch of surrogate embedding neural network training inputs:
processing, by the surrogate embedding neural network, the surrogate embedding neural network training input that excludes the training user data specific to the second service platform to generate a training surrogate cross-platform feature embedding; and
determining one or more updates to parameter values of the surrogate embedding neural network based on minimizing a distance between the training cross-platform feature embeddings and the training surrogate cross-platform feature embeddings.

20. The one or more non-transitory computer storage media of claim 11, wherein the current user session is a search session that includes a search action, and the session data comprise data related to the search action.
